(19) United States
(12) Patent Application Publication
(10) Pub. No.: US 2013/0238380 A1
(43) Pub. Date: Sep. 12, 2013

(54) System and Method for Scheduling Effective Client Conferences with Financial Advisors

(71) Applicant: Richard L. PETERSON, Los Angeles, CA (US)

(72) Inventor: Richard L. PETERSON, Los Angeles, CA (US)

(21) Appl. No.: 13/417,117

(22) Filed: Mar. 9, 2012

(51) Int. Cl. G06Q 10/10; G06Q 40/00

(52) U.S. Cl. 705/7.24; 705/35; 705/7.12

(57) ABSTRACT

A business-support system for financial advisors accepts personality information from investors and market-activity indicators such as share price, trade volume and natural-language news tone and sentiment reporting, to identify investors who may benefit from counseling from their advisors. The advisors may be notified to contact their clients, or a conference may be scheduled via a Customer Relationship Management (“CRM”) system. Additional features and extensions are described and claimed.

### CONTINUITY AND CLAIM OF PRIORITY

This is an original U.S. patent application.

### FIELD

The invention relates to automated business practice management. More specifically, the invention relates to systems and methods for scheduling customer counseling and advising sessions in response to automatically-detected financial market conditions.

### BACKGROUND

Various sectors of the economy wax and wane in activity as time passes. Presently, financial services account for a large share of economic activity, and it has become very common for individuals—even those of relatively modest means—to participate in investment activities. The growth of the investing population, and the increase in number of less-experienced investors, has been a boon to the investment advice and services industry.

Although one might imagine that comparisons between investment advisors (and therefore business competition between them) should depend primarily on the bottom-line results experienced by their clients, in reality, factors not directly related to investment results are critical for advisors to attract and retain clients. Investors evaluate their advisors on the accuracy and profitability of their advice, of course, but also on the timeliness of the advice and other quality-of-service measures. Thus, methods for helping financial advisors improve aspects of their client service apart from simple data analysis and prognostication may be of value in this field.

### SUMMARY

Embodiments of the invention use client personality and psychological data, typically collected as part of a new-client intake process, to set alerts or alarm points. If the system detects market or financial conditions matching these set points, it automatically starts a business workflow to ensure that the client receives timely communications, counseling, and recommendations.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a flow chart outlining operations according to an embodiment of the invention.

FIG. 2 shows a sample environment, indicating some of the parties and systems that may be involved in the operation of an embodiment.

FIG. 3 is a block diagram showing some of the logical functions that may be found in an embodiment.

FIG. 4 shows a sample portion of a personality inventory that can be used with an embodiment of the invention.

### DETAILED DESCRIPTION

When an investor begins working with a new financial advisor, the advisor often conducts an interview to learn the nature and extent of the investor's holdings, his financial goals and timeline, and other information to help ensure that the advisor's recommendations will be in sync with the investor's objectives. A common goal in this interview is to discover clues about the investor's personality: this information can be critical in crafting a successful investment strategy. For example, a timid or risk-averse client may be unwilling or constitutionally unable to follow an investment plan that offers substantial returns, if those returns are likely to be accompanied by great volatility. On the other hand, an overly-conservative strategy may be disappointing to a more adventurous investor (in addition to yielding lower-than-desired returns). The investor's risk tolerance is an important personality trait that the advisor needs to know and accommodate.

Investor personality information can be collected through an oral interview, through a standardized questionnaire, or through combinations of similar means. In addition, a long-lived profile may be developed and modified as new information becomes available. For example, an advisor may contact the investor quarterly or annually to inquire about significant life events or other circumstances that might affect the investor's plans, and this information (including from repeated or follow-on surveys and questionnaires) can be incorporated into the profile.

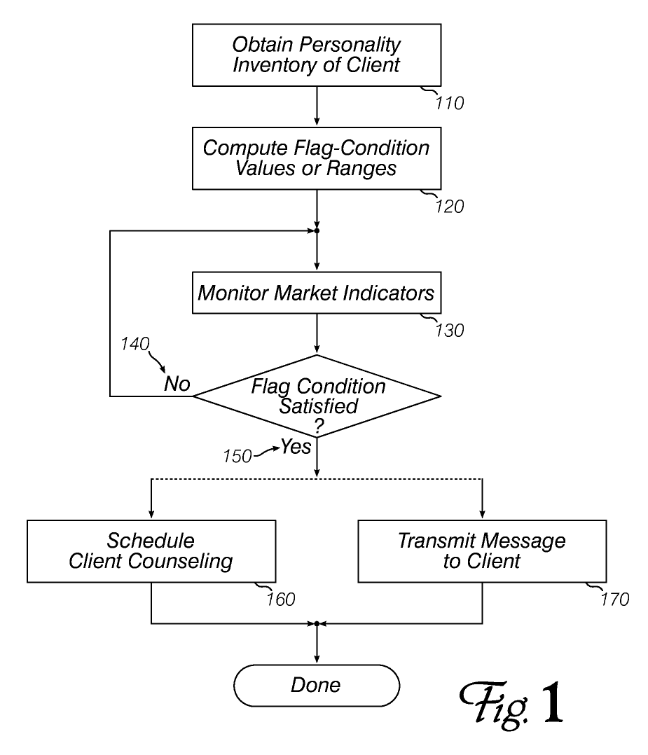

An embodiment of the invention operates using personality information (represented in a form that permits comparison and other arithmetic operations), as well as other information discussed below, and live or real-time information about actual financial events, roughly as outlined in the flowchart of FIG. 1.

At 110, the system obtains a personality inventory of a client. The inventory can be collected manually (e.g., through in-person interviews, with data and assessments entered later) or automatically (e.g., through a computer-administered questionnaire), and may be a dynamic profile, updated from time to time with new information. The inventory includes information or assessments about various personality traits, such as risk tolerance, aggression, emotional sensitivity, novelty-seeking, openness to new experiences, agreeableness, and conscientiousness and psychological conditioning derived from family history, investment experience, and demographic information. The inventory results are represented in a form that can be manipulated numerically by a computer. For example, risk tolerance may be represented by a number from 0 (no tolerance—extremely risk-averse) to 10 (heedless of risk).

The system computes one or more “flag conditions” based in part on the personality traits (120). A flag condition is a numeric value or range for a financial market indicator that might be significant to the client. For example, for a risk-averse client, the system might compute a “panic” flag condition that would be triggered if a general market indicator such as the Dow Jones Industrial Average (“DJIA”) value falls more than 6% in a day, or more than 10% over three days. (The panic flag condition for a more-intrepid investor might have higher limit values.)

Next, the system monitors market indicators (130) and compares them to the previously-computed flag conditions. If no condition is satisfied (140), monitoring simply continues. However, if a condition is met (150), then the system takes a responsive action, such as scheduling a client counseling session (160) or contacting the client directly with an automatically-generated message (170).

The purpose of the counseling session (or the message, if sent automatically) is to reinforce the investment plan, and to dissuade the client from acting rashly based on short-term market conditions. The rash action may be, for example, panicked selling of securities in a temporarily falling market, or irrational buying during a brief surge.

Automatically managing flag conditions for clients, and automatically monitoring market indicators for situations that might entice a client to abandon a carefully-planned portfolio strategy, can help an advisor to provide timely, proactive advice to a larger number of clients. An advisor may take a “just-in-time” counseling approach, reducing the number of regularly-scheduled counseling contacts in favor of conferences that occur when—based on the client's personality—they may be most effective or most needed.

It is important to recognize that embodiments of the invention are not simply blunt, automatic instruments for scheduling reassurance conferences with “Nervous Nellie” investors when the market falls. The personality inventories are multi-dimensional and—in preferred embodiments—quite detailed. Furthermore, as discussed below, the financial market news and information is typically processed to extract forward-looking sentiment information—that is, client expectations (often embodied in emotional expressions and communication style) and information about where investors think the market might go, and not merely where it has recently gone. This information naturally feeds into an investor's decision-making process, and embodiments of the invention help an advisor to reach a client before he has decided (based on information available to him) to take an investment action. An advisor's task is greatly complicated if his client has already decided to buy or sell. Embodiments detect conditions that lead investors to start thinking about changing their positions, and give the advisor an opportunity to reach the investor before the thought has crystallized into a resolve to act.

A basic embodiment of the invention provides timely, personality-based alerts for a single investor (and optionally, communications advice and “red flags” for that investor's financial advisor). However, the computational and communication-bandwidth requirements for such a system are quite modest. A preferred embodiment can serve many investors and their advisors simultaneously. In addition, the collection and analysis of financial market indicators need only be clone periodically, since all investors participate in the same global market, and by and large have access to the substantially the same news and information.

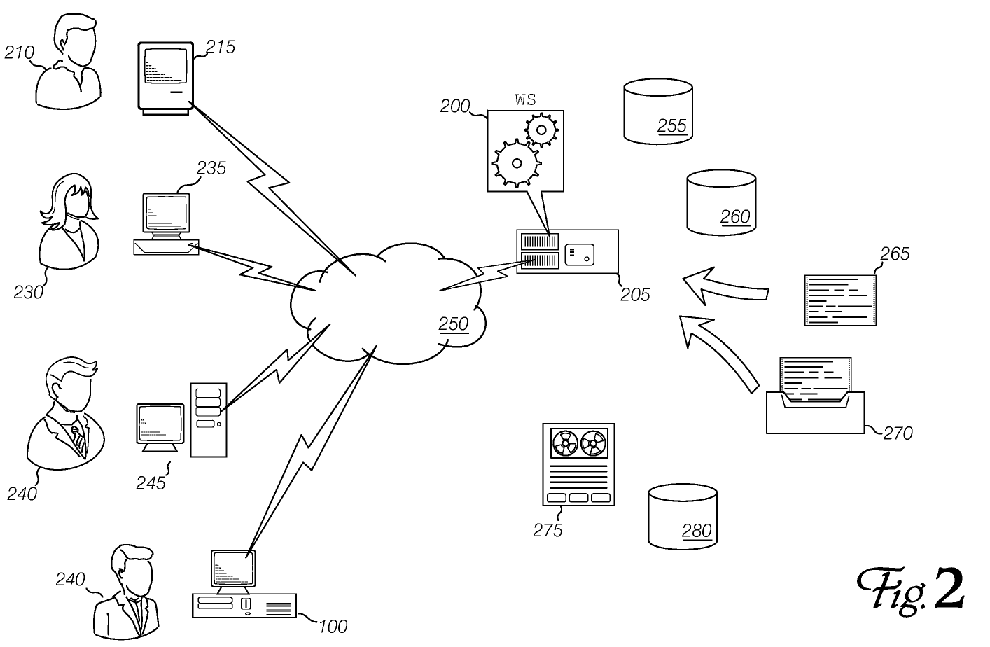

FIG. 2 outlines some of the participants and communication pathways in a preferred embodiment. A provider offering services according to an embodiment operates a web server 200 on a computer 205 at its data center. Investors 210, 220 using their personal computers 215, 225 interact with the web server to complete personality surveys and view portfolio and financial data. Client computers (and in particular, web browser software executing at a client computer) may use the Hypertext Transfer Protocol (“HTTP”) or a secure version of HTTP known as “HTTPS” to carry the data comprising these interactions.

Financial planners 230, 240 may also interact with web server 200 via their computers 235, 245, to review client alarm triggers, current financial indicators, and so on. Communications between computers may be carried over a distributed data network 250 such as the Internet.

The provider's computer 200 (or another nearby computer, if the logical functions are separated from the web server) has access to databases 255, 260 containing personality inventories of the investors and alert or flag-condition data. Real-time market data 265, news 270 and other sources of information are received by monitoring logic (not shown) and used to construct market indicators, which are compared with the alert set-points and ranges to determine whether an investor is likely to benefit from a consultation with his or her advisor. If an alert is triggered, the system may contact the investor directly, contact the advisor, or initiate a work-flow item that will result in the advisor contacting the client. For example, the provider may transmit a scheduling instruction to an external customer-relationship management (“CRM”) service provider 275, where it is entered into a database 280 that is referred to by an advisor's calendaring system. A provider offering services according to an embodiment may operate the scheduling system itself, but integration with legacy CRM systems is frequently preferred.

An embodiment of the invention may identify and schedule effective counseling opportunities even more accurately if it is provided with information beyond the investor personality profiles and real-time market data. For example, if details of the investor's holdings are available, then market indicators of particular relevance to the investor's portfolio can be monitored and used to trigger alerts. Furthermore, alerts can be divided by severity or importance: an indicator of market trouble for a stock held by a risk-averse investor may nevertheless be relatively low priority, if the portfolio contains only a small amount of that asset. On the other hand, indicators relevant to a significant position in a portfolio may be considered higher priority, and a financial advisor may wish to receive an immediate email or text message so that the client can be contacted right away.

An embodiment may also implement flags or alerts based on related investors' personality profiles. For example, spouses may jointly own assets in a portfolio, but their separate personality profiles may suggest counseling at different times and for different concerns. An advisor may be alerted with specific recommendations to counsel the more risk-averse spouse during a downturn, and the more risk-seeking spouse during a bull run.

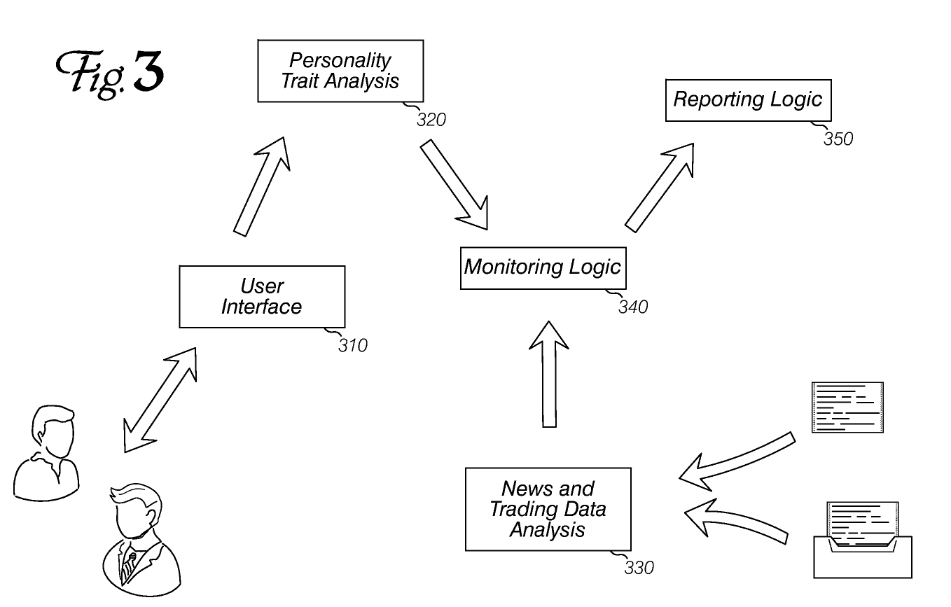

FIG. 3 is a block diagram showing some of the logical functions that may be combined in an embodiment. These functions may be performed by a single computer or distributed among several cooperating computers. A system implementing an embodiment need not be dedicated to that service; it may provide other services as well. A user-interface function 310 provides information to investors and advisors, and may administer personality surveys and collect survey responses. Personality-trait analysis function 320 computes alert set-points and ranges based on personality information (and, optionally, on other information that may be available). Set-points and ranges may be dynamic, that is, recomputed from time to time based on market activity or the arrival of other new information. Some embodiments are completely dynamic: a specific set point is not computed in advance, but rather, personality information (and other investor data) is reviewed in connection with current market data and news content and sentiment to decide whether a client conference is likely to be useful.

News and trading-data analysis function 330 may process real-time data to produce derived quantities that map better to personality traits. Although a basic embodiment of the invention might simply compare a raw number such a stock price or trading volume to a personality-dependent threshold value, more sophisticated systems use current and historical data to calculate a composite value that can be thresholded or ranged to anticipate effective counseling opportunities. When information about a client's assets (rather than just his psychological profile) is available to the system, the news and trading-data analysis may filter (ignore) or deemphasize news that does not relate to the client's holdings.

Monitoring logic 340 implements the core method of an embodiment by comparing the (possibly dynamic) flag conditions created from each investor's personality inventory with (possibly composited) market-indicator data to identify investors who may be at risk of making irrational investment decisions. As mentioned above, when information beyond the personality inventory is available, monitoring logic may take the information into account when determining whether the market conditions, considered in view of the investor's personality and other information, warrant the scheduling of a counseling session.

Finally, reporting logic 350 provides useful information and direction for financial-advisor subscribers to the system. Reporting logic 350 may, for example, keep a history of minor disturbances that the advisor might wish to mention at the client's next regular interaction, schedule an extra status conference during a period of moderate turmoil, or notify the advisor immediately if a client's personality traits and financial holdings, combined with current market indicators, suggest that the client would appreciate and benefit from an emergency counseling session.

An embodiment's reporting logic may produce messages, such as electronic-mail messages, providing advice and/or sample interaction scripts to assist an advisor in dealing with a client during one of the scheduled conferences. The following paragraphs show example messages delivered by one embodiment. For a client with a “Financial Anxiety” estimate of 2.8, and market conditions giving rise to a “Fear Index” of 0.04 (both numerical values are in arbitrary units, and based on an actual implementation operated by the inventor):

Dear ADVISOR [YELLOW ALERT]:
Given the recent market volatility, your client [CLIENT NAME] is going to be feeling pretty nervous. This provides a great opportunity for you to help him stay on track by nipping any anxiety in the bud. This will also build a stronger and closer relationship—one that he'll tell his friends about. We recommend you take the following steps, using the IDEAS script as a guide:
1. Call [CLIENT NAME] to find out how he's dealing with the recent market volatility. He'll be grateful for your thoughtfulness.
2. Offer to send him a research report on current events and their likely economic impact.
3. If your FSMaP is activated, schedule a time for him to come into the office and discuss your plans going forward.
4. If he is quite shaken by recent events, consider reframing the conversation with the SlideShow technique to help him refocus on the long term.

For Financial Anxiety >2.8 and Fear Index >0.05:

Dear ADVISOR [RED ALERT]:
Given the recent market selloff, your client [CLIENT NAME] is going to be feeling panicky. You can take this opportunity to help him stay on track by addressing his anxieties proactively. He needs to feel that you have some control and mastery over the situation. This will also build a stronger and closer relationship—one that he'll tell his friends about. We recommend you take the following steps, using the IDEAS script as a guide:
1. Call [CLIENT NAME] to find out how he's dealing with the recent market volatility. He'll be grateful for your thoughtfulness.
2. Offer to send him a research report on current events and their likely economic impact.
3. If your FSMaP is activated, schedule a time for him to come into the office and discuss your plans going forward.
4. If he is quite shaken by recent events, consider reframing the conversation with the SlideShow technique to help him refocus on the long term.
5. It's OK to “throw a maiden in the volcano” to please the market gods—sell a small portion of an extremely painful position so that your client has some perspective and breathing room.

“Excitement Seeking” >3.0 and “Optimism Index” >0.01

Dear ADVISOR [GREEN ALERT]:
Your clients are probably seeing green and feeling good these days. If they enjoy watching their stocks go up, they're probably thinking it would be a good time to buy even more. [CLIENT NAME] is going to be feeling smart and confident about his investing skills, and he is probably considering taking additional investment risk. You can reach out to him now and help him stay on track by proactively addressing his desire to take more risk. This isn't an easy thing to do—it's never pleasant to rein in exuberance during a bull market. We recommend you take the following steps, using the IDEAS script as a guide:
1. Call [CLIENT NAME] to find out his thoughts about the rally. He'll be glad to hear from you.
2. Ask him about his thoughts about investing going forward. If he's more bullish than ever, then
3. Remind him of the risks that lurk beneath the surface. Remind him that it's times like these when the best opportunities lie in preserving capital—keeping “your powder dry” until the next selloff.
4. If he is overwhelmingly bullish, give him your blessing to take the extra risk, and ask his permission to implement a sell rule that will trigger in case of a common sell signal such as a 200-day moving average crossover.

Excitement-Seeking >3.0 and Optimism Index >0.02:

Dear ADVISOR [BRIGHT GREEN ALERT]:
The current market environment is one in which you probably don't want to be taking any upside risk. It can be painful to watch a bull market such as this run away from you, but when the crack comes it will come swiftly, so it's usually best to stay on the sidelines. Your clients will want to be 100% long, and probably even leveraged. Be careful because the low volatility climate we're in now seldom lasts and usually affects the economy when it unwinds.
[CLIENT NAME] is going to be feeling smart and confident about his investing skills, and he is probably taking excessive investment risk at this stage, without realizing it. Make sure he gets a last sip before the market gods take away the punch bowl.
1. Invite [CLIENT NAME] in for a sit down meeting. He'll be glad to hear from you.
2. Ask him about his current leverage and business risks. If he's more bullish than ever, then remind him of the risks that lurk beneath the surface. Explore where those might be with him.
3. Give his business and his portfolio a stress test under different dire economic or market conditions. Remind him that it's times like these when the best opportunities lie in preserving capital—keeping “your powder dry” until the next selloff.
4. If he is overwhelmingly bullish, give him your blessing to take the extra risk, and ask his permission to implement a sell rule that will trigger in case of a common sell signal such as a 200-day moving average crossover.

Other market sentiments, such as “Gloom,” “Anger,” “Distrust” and “Enthusiasm,” can be estimated numerically using techniques such as those disclosed in co-pending patent application Ser. No. 13/300,573, entitled Method and Apparatus For Automatically Analyzing Natural Language to Extract Useful Information, the disclosure of which is incorporated by this reference. The abstract sentiments detected by that method—which are reported in a numeric form suitable for manipulation and comparison as described here—can be used in conjunction with psychological profiles and their corresponding trigger points. Forward-looking (predictive) sentiments and upward-trending “buzz” topics (things that are becoming common subjects of discussion) are especially useful in embodiments of this invention, since they reflect the subjects and events that market participants are beginning to pay attention to. For investors with correspondingly susceptible personality traits, this may be when they begin to formulate investment plans, and when an advisor's counsel can have the biggest effect.

Each of these sample messages may also include other convenient information, such as a contact phone number for the client, reference information about the client's portfolio or notes from previous encounters.

One implementation detail that has been found to be useful is to associate a mascot or totem with a client. For example, an animal or imaginary creature such as an elf or a dwarf, which is conventionally thought to have certain skills, innate characteristics or qualities, may be used to help focus the client's attention. Such an avatar, chosen on the basis of the investor's psychological profile, allows an advisor to redirect criticisms away from the client, and make them a fault of the avatar (notwithstanding its many other excellent characteristics). An advisor's recommendation, cast in the form of a fable about the investor's “clever monkey” avatar, may be more effective at dissuading an exuberant investor from taking on more risk in an overvalued market than a rational explanation of valuation fundamentals and short-term statistical anomalies. The avatar may also provide a useful shorthand for an advisor to group a general set of psychological characteristics. In other words, market conditions may cause an embodiment to schedule counseling sessions with many “grasshoppers,” and those clients may have similar concerns or be favorably influenced by similar advising approaches.

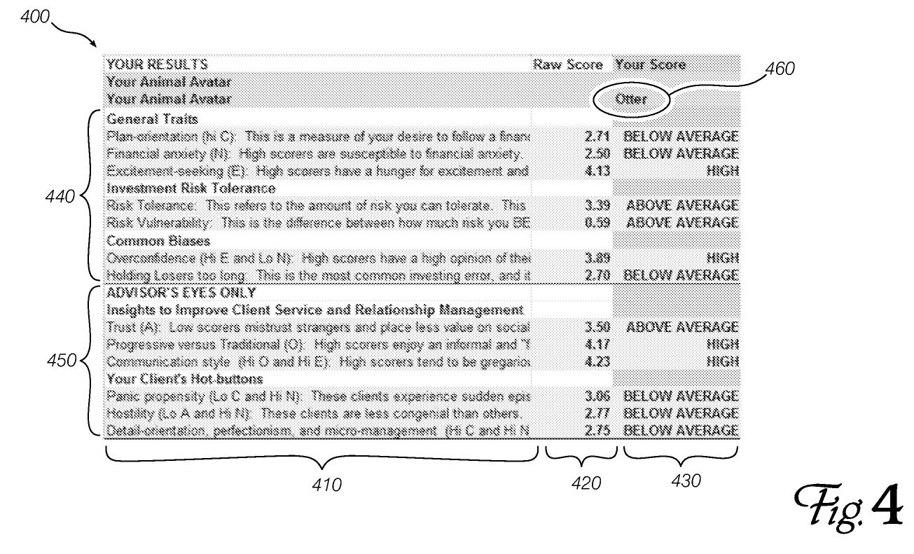

FIG. 4 shows a portion of a personality inventory, 400, that may be used in an embodiment of the invention. After asking the investor a number of questions, the answers are processed to produce numeric estimates of various characteristics relevant to the investor's style, goals and weak points. An inventory may include expanded text descriptions 410 of individual scores 420, as well as a lower-granularity “high/medium/low” assessment 430 of the scores. Portions of the inventory 440 may be displayed to the investor, while other portions 450 may be reserved for review by the financial advisor only. At 460, the automatically-chosen avatar is displayed (the investor represented by this profile is an “Otter.”)

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that financial-advice client counseling needs can also be anticipated by software and hardware that distribute the functions of embodiments of this invention differently than herein described. Such variations and implementations are understood to be captured according to the following claims.

1. A method comprising:
obtaining a result of a personality inventory of a client, the result including a plurality of personality traits;
constructing a flag condition based on the personality inventory;
monitoring a financial market indicator; and
if the indicator satisfies the flag condition, initiating a workflow to prompt a financial advisor to counsel the client.

2. The method of claim 1 wherein the flag condition is a first flag condition, the method further comprising:
repeating the obtaining and constructing operations for a second client to construct a second flag condition based on the personality inventory of the second client; and wherein
the monitoring is to determine whether the financial market indicator satisfies any of the first flag condition or the second flag condition.

3. The method of claim 1 wherein initiating a workflow comprises scheduling an appointment in a Customer Relationship Management (“CRM”) system.

4. The method of claim 1 wherein monitoring a financial market indicator comprises:
performing automatic natural-language processing to extract a numerical estimate of a strength of an abstract sentiment in a financial news story.

5. The method of claim 4 wherein the abstract sentiment is a forward-looking expectation.

6. The method of claim 4 wherein the abstract sentiment represents a buzz about a topic in the financial news story.

7. The method of claim 1, further comprising:
assigning a mascot to the client, the mascot chosen based on the personality inventory of the client.

8. The method of claim 7 wherein the mascot is an animal.

9. A non-transitory computer-readable medium containing data and instructions to cause a programmable processor to perform operations comprising:
accepting numeric personality-inventory scores of a client;
computing an alert range for a financial market indicator based on the numeric personality-inventory scores;
sampling the financial market indicator; and
if the financial market indicator falls within the alert range, transmitting a message to cause a financial advisor to contact the client.

10. The computer-readable medium of claim 9, containing additional data and instructions to cause the programmable processor to perform operations comprising:
administering a plurality of survey questions to the client;
collecting a corresponding plurality of survey answers from the client, and
wherein accepting the numeric personality-inventory scores of the client comprises calculating the numeric personality-inventory scores from the plurality of survey answers.

11. The computer-readable medium of claim 10, containing additional data and instructions to cause the programmable processor to perform operations comprising:
administering a second plurality of survey questions to the client;
collecting a second corresponding plurality of survey answers from the client; and
updating the numeric personality-inventory scores of the client according to the second corresponding plurality of survey answers.

12. The computer-readable medium of claim 10 wherein the administering and collecting operations are performed by exchanging messages with a client computer, the messages structured according to one of a Hypertext Transfer Protocol (“HTTP”) or a Secure Hypertext Transfer Protocol (“HTTPS”).

13. The computer-readable medium of claim 9 wherein transmitting a message comprises transmitting an electronic mail message to the financial advisor.

14. The computer-readable medium of claim 9 wherein transmitting a message comprises transmitting a Small Message Service (“SMS”) text message to the financial advisor.

15. The computer-readable medium of claim 9 wherein transmitting a message comprises transmitting a scheduling request to cause a Customer Relationship Management (“CRM”) system to place an appointment on an electronic calendar of the financial advisor.

16. A system comprising:
user interface means for receiving personality-inventory survey answers;
personality analysis means for computing alert conditions from the personality-inventory survey answers;
a news analysis module to receive real-time financial news and social media text articles and produce a numeric measure of market sentiment;
a monitoring module to detect if the market sentiment satisfies an alert condition; and
a reporting module to cause a financial advisor to contact an investor associated with the alert condition.

17. The system of claim 16 wherein the news analysis module is to weight the market sentiment according to an asset held by the investor.

18. The system of claim 17 wherein the news analysis module is to disregard financial market data pertaining to assets not held by the investor.

19. The system of claim 16 wherein the news analysis module is to automatically process a natural-language news or social-media article to produce a numeric estimate of an abstract sentiment.

20. The system of claim 19 wherein the abstract sentiment is uncertainty.
